(19) United States
(12) Patent Application Publication
(10) Pub. No.: US 2014/0331532 A1
(43) Pub. Date: Nov. 13, 2014

(54) FLEXIBLE CLEAR AND TRANSPARENT LIGHTING STRIPS AND SIGNAGE

(71) Applicant: ALMAX MANUFACTURING CORPORATION, Kirkland, WA (US)

(72) Inventor: Robert W. Deppiesse, Bothell, WA (US)

(73) Assignee: ALMAX Manufacturing Corporation, Kirkland, WA (US)

(21) Appl. No.: 13/890,127

(22) Filed: May 8, 2013

(51) Int. Cl. F21S 4/00; G09F 13/00

(52) U.S. Cl. CPC F21S 4/005; G09F 13/00
USPC 40/541; 362/223; 362/221; 228/170; 156/256

(57) ABSTRACT

Lighting strips and signs are produced using a flexible, clear and transparent substrate that is a good dielectric, such as polyethylene terephthalate (PET). Flexible metallic power bus traces are formed on at least one surface of the substrate, extending along opposite edges of the strip, or to define the shape of alphanumeric letters or graphic designs on a sign. Conductive traces electrically coupled to the flexible power bus traces are electrically connected to a plurality of light emitting devices, such as light emitting diodes (LEDs). The flexible, clear and transparent lighting strips or signs can then be mounted or hung on a window or in a display case and provide decorative lighting and illumination without obscuring objects, since light is transmitted through the substrate. The light emitted by the light sources can be white or selected to be of one or more other colors for enhanced visual and decorative effect.

### BACKGROUND

In recent years, lighting strips have become commonplace in residential, retail, and commercial applications, to provide both decorative lighting effects and illumination. With the increasing availability of low cost LEDs, it has become economical to produce relatively long lighting strips that can be attached to various surfaces, depending upon the specific application. Since the lighting strips can be made using a substrate that is sufficiently flexible to be applied to curved surfaces and used in applications where the lighting strips must extend around relatively sharp corners, there are many applications for such strips. However, such lighting strips are inherently both visually conspicuous and obtrusive in nature. Because of the materials and processes that have been used to manufacture these lighting strips, they are generally unattractive. For example, the type of plastic currently used for the substrate to which the LEDs are mounted when making flexible LED lighting strips is bright orange in color and completely opaque. In applications where the LED lighting strips are hidden from view, the visual appearance of these lighting strips is not a significant problem. However, there are many applications in which the lighting strips must be decorative, such as in display cases or windows where the lighting strips are fully visible, both when lighted and not. In these prospective decorative and highly visual applications, the flexible LED lighting strips currently available are often not used because of their undesirable visual appearance and lack of transparency.

The base circuit materials currently most often used for making flexible LED lighting strips like those discussed above is a copper-clad polyimide substrate. LEDs are mounted on conductive pads on the using solder reflow techniques that employs either conventional tin or tin/lead solder. The melting point of such solder is relatively high, e.g., from about 350 to about 600 degrees Fahrenheit; however, the polyimide substrate can readily withstand such processing temperatures without melting.

In consideration of the above-noted undesirable visual appearance and lack of transparency that are characteristics of conventional flexible LED lighting strips, it would be desirable to create a flexible LED lighting strip that is both functional in providing good quality illumination and which is transparent and clear, thus enhancing it's decorative appeal when used in applications where the flexible lighting strip is visible. Such an LED strip would be functionally different than currently available lighting strips because it could be advantageously displayed in windows, freely applied inside display cases, and used in other applications where the lighting strip is clearly visible and not hidden from view. Such transparent flexible strips would be more desirable because they would not be limited to use in applications where they are hidden from view, and because they would not obscure objects disposed behind the lighting strips. Such strips would be easier to place and use in decorative applications and more attractive in appearance than the conventional, colored opaque flexible lighting strips.

While plastics are commercially available for use as substrates of a lighting strip that are flexible, clear, and transparent, such plastics cannot withstand the melting point temperatures of conventional solder. Accordingly, it would be desirable to develop an approach for electrically connecting and mounting light emitting devices such as LEDs, and other components such as current limiting resistors to copper or other types of flexible metal conductive traces and pads without damaging the substrate material by exposing the material to temperatures beyond its maximum processing limit. The approach used should be relatively low in cost and enable cost efficient manufacturing of flexible clear and transparent lighting strips that may be many feet in length.

The ability to produce flexible clear and transparent lighting strips might also be extended to other types of products. For example, the same approach used to make clear and transparent lighting strips could be applied to producing various types of lighted signs that might be advantageously displayed in windows or used in display cases. Since the substrate on which the LEDs (or other types of light emitting devices) are mounted would then be clear and transparent, such a sign would not obscure objects disposed behind the lighted sign. The lighted sign would appear to float in space, since the conductive traces used to supply power to the light emitting devices can be made sufficiently thin in cross section or width to be substantially visually unnoticeable. While some applications may require a lighted sign that is sufficiently flexible to conform around a curved surface or to be flexed, in many applications in which a lighted sign would be generally planar, the substrate used to make the sign would only need to be clear and transparent, but not necessarily flexible.

### SUMMARY

Accordingly, the following discussion is directed toward flexible lighting strips that are constructed using a non-transparent flexible conductive metal, such as copper, which is applied to a flexible, clear and transparent substrate. For example, a copper clad substrate formed of a polyethylene terephthalate (PET) base material can be used to produce the flexible lighting strip. The flexible conductive metal cladding can be selectively removed from the substrate using a subtractive process to form a desired circuit that includes a plurality of flexible power bus traces, and conductive traces used to convey an electrical current to light emitting devices mounted on the flexible, clear and transparent substrate. However, PET plastic has a maximum processing temperature sufficiently low to preclude mounting components to a flexible lighting strip made of this material using conventional solder, without damaging the substrate. Instead, the components can be mounted on the conductive metal circuitry formed on the flexible, clear and transparent substrate using a solder alloy formulated to melt at a temperature less than maximum working or processing temperature of the substrate, or using a conductive epoxy.

For example, a reflow solder alloy of materials such as Tin, Indium and Bismuth can be formulated to have a lower melting temperature than the maximum working or processing temperature that substrate materials such as PET can withstand (e.g., less than about 250 degrees Fahrenheit). Alternatively, a conductive epoxy can also be used to attach light emitting devices and other electrical components to the conductive metal circuitry formed on the substrate, to avoid damaging the substrate by exposing it to excessive temperatures.

The same approach can be used to create lighted signs having a graphic design and/or one or more alphanumeric characters represented by a plurality of light emitting devices mounted on a clear and transparent substrate. This substrate may also be flexible if necessary for specific applications of a lighted sign, such as for signs that must be flexible to conform to a non-planar surface. A plurality of non-transparent flexible power bus traces formed on the clear and transparent substrate define the shape of the graphic design and/or one or more alphanumeric characters and conduct electrical current to the light emitting devices through a plurality of conductive traces that are also formed on the substrate. The lighted sign can be hung or mounted on a window or in a display case without obstructing objects behind the lighted sign and can provide a pleasing visual appearance.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a schematic plan view of an exemplary embodiment of a flexible, clear and transparent lighting strip in accord with the approach described herein;

FIG. 2 is a plan view of a roll of an exemplary flexible, clear and transparent lighting strip similar to that shown in FIG. 1, but without a termination tab on the side for connecting to a DC power source;

FIG. 3 is a plan view of an exemplary lighted sign that is clear and transparent, and optionally, flexible;

FIG. 4A is a more detailed schematic view of a section of an exemplary flexible, clear and transparent lighting strip like that of FIGS. 1 and 2;

FIG. 4B is a schematic plan view of the exemplary flexible, clear and transparent lighting strip of FIG. 4A, showing how the components are attached to the conductive flexible metal traces on the flexible, clear and transparent substrate using either conductive adhesive, or a solder alloy that melts at a temperature below the maximum working or processing temperature of the flexible substrate; and

FIG. 4C is a cross-sectional view of the exemplary flexible, clear and transparent lighting strip of FIG. 4B, taken along section line 4C-4C, showing how conductive terminals on the components are attached to conductive pads of flexible conductive metal traces that are formed on the flexible substrate.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

### Exemplary Embodiment of Flexible, Clear & Transparent Lighting Strip

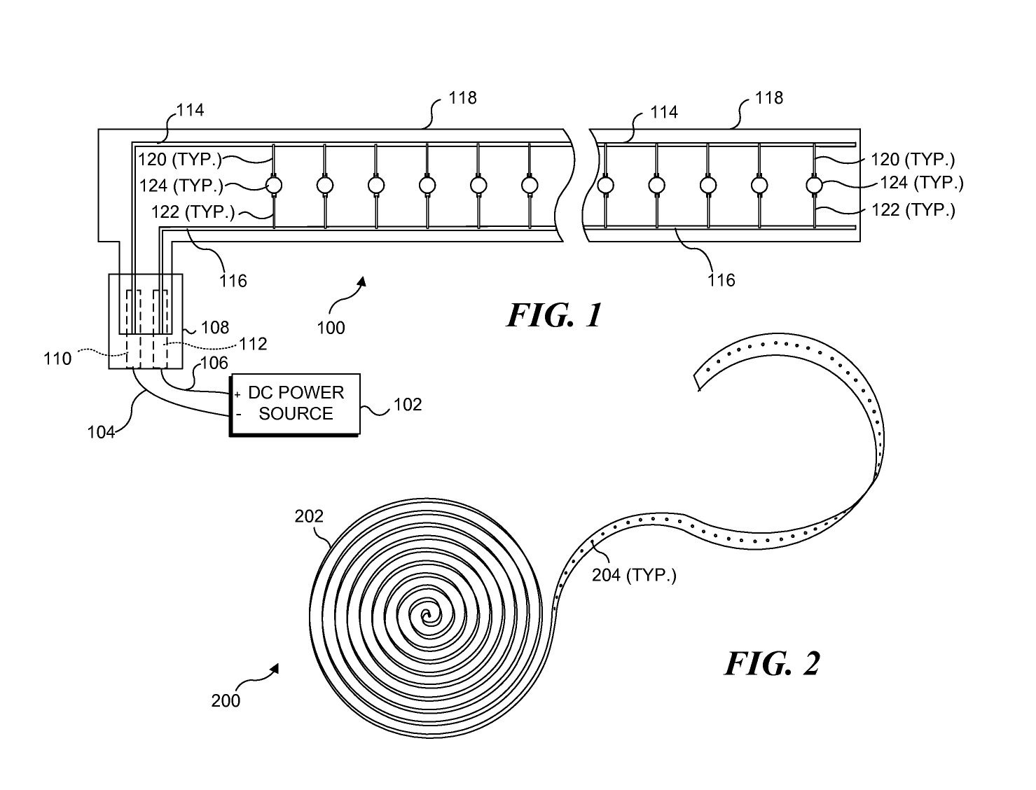

FIG. 1 illustrate a portion of an exemplary embodiment of a flexible, clear and transparent lighting strip 100 in accord with the present novel approach. Lighting strip 100 is fabricated on a flexible substrate 118 that is both clear and transparent to light in the human visual spectrum. In that regard, flexible substrate 118 differs from prior art flexible lighting strips that are flexible, but neither clear nor transparent. As noted above, polyimide plastic has been used for the substrate of flexible lighting strips, but it is generally orange in color and opaque. In contrast flexible substrate 118 can be made from a plastic such as polyethylene terephthalate (PET), which is flexible and characterized by being colorless, and both clear and transparent. It should be understood that other types of plastic or other materials may alternatively be used for flexible substrate 118 if they are sufficiently flexible, clear and transparent for the intended application, and are electrically non-conductive (i.e., have a high dielectric characteristic). For example, new types of polyimide film have been developed that are clear, and colorless, but it does not appear that this material is commercially available at a sufficient thickness to support the light emitting devices used on a flexible lighting strip. Other materials that might be used for flexible substrate 118 include polycarbonate, and polycarbonate/PET blends. In applications where only a minimal degree of flexibility is required, even thin glass sheets can be used for flexible substrate 118.

Conductive flexible power bus traces 114 and 116 are formed on at least one surface of flexible substrate 118. For example, the flexible power bus traces can be formed by applying a flexible conductive foil or cladding layer of a non-transparent metal over one or both surfaces of flexible substrate 118 and then removing all but the desired metal required for the flexible power bus traces, and for the conductive traces, using a subtractive process such as acid or laser ablation, or using other well-known conventional techniques for forming conductive metal traces on substrates. The flexible power bus traces and conductive traces can be formed, for example, of silver, copper, or other types of flexible conductive metals that are non-transparent, without any intended limitation. Since the flexible power bus traces are relative narrow in width, they do not have a sufficient cross-sectional area or size to be visually apparent and do not obscure objects disposed some distance behind them.

In the example shown in FIG. 1, a direct current (DC) power source 102 is electrically connected to flexible power bus traces 114 and 116. DC power source 102 is connected to leads 104 and 106, which are electrically coupled to conductive terminals 110 and 112 in a push-on connector 108. DC power source 102 can be coupled to an alternating current (AC) line plug (not shown) or may be battery powered. The DC power source supplies an electrical current at a voltage level appropriate to energize light emitting devices 124. Push-on connector 108 is seated over a side tab 126 disposed on one edge and at an end of flexible substrate 118, so that flexible power bus traces 114 and 116 respectively electrically connect to conductive terminals 110 and 112. At the time that flexible power bus traces 114 and 116 are formed on flexible substrate 118 as described above, conductive traces 120 and 122 can also be formed and are coupled respectively to flexible power bus traces 114 and 116 at each spaced-apart location where light emitting devices 124 are to be mounted on flexible substrate 118.

In this exemplary embodiment, light emitting diodes (LEDs) are used for light emitting devices 124. Further, to minimize the thickness of flexible, clear and transparent lighting strip 100, it may be preferable to use “bare” LEDs, which do not include a housing or lens. However, it should be understood that the present novel approach is not in any way limited to the use of LEDs on the flexible, clear and transparent lighting strip. Other types of light emitting devices, such as laser diodes, organic light emitting diodes (OLEDs), incandescent bulbs, and other devices that emit light when energized by an electrical current might alternatively be used instead of LEDs on flexible, clear and transparent lighting strip 100.

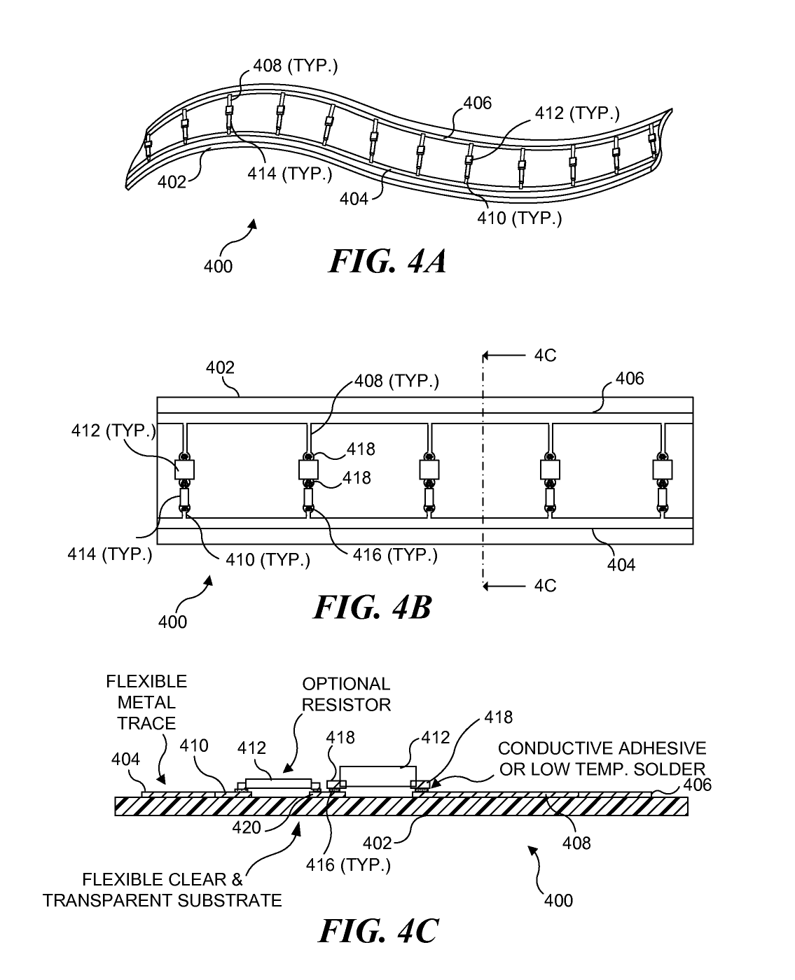

While not shown in FIG. 1, it is contemplated that a current limiting resistor might be included between DC power source 102 and connector 108. Optionally, as a further alternative, each of a plurality of current limiting resistors might be electrically connected in series between one of flexible power bus traces 114 and 116 and each light emitting device 124. Examples of such current limiting resistors are shown in FIGS. 4A, 4B, and 4C. It is also contemplated that a current regulated DC power source 102 can be used to limit the total current supplied to the flexible, clear and transparent lighting strip, based on the total number of light emitting devices mounted thereon.

While the resolution in FIG. 1 does not enable details of the connection of light emitting devices 124 to conductive traces 120 and 122 to be shown, it will be understood that the light emitting devices must be mounted so that their electrical terminals are connected to conductive traces 120 and 122 (or to conductive pads formed at the ends of the conductive traces). However, if a material such as PET is used for flexible substrate 118, techniques using conventional solder for electrically connecting the light emitting devices to the conductive traces will damage the flexible substrate, since conventional solder, i.e., tin or tin/lead alloy, requires processing at up to 600 degrees Fahrenheit to melt the solder. Although the melting point of PET is in the range of 484-500 degrees F., the maximum stable processing or working temperature for a sheet (or strip) of PET is about 250-260 degrees F. Thus, conventional solder or solder alloys commonly used for soldering electronic components cannot be used with flexible substrates made of PET plastic. However, there are many alloys usable as solder that have melting points below the stable processing temperature of PET. Examples of such alloys are shown below in Table 1, from an article entitled, “Low-Temperature Solders,” by Zequn Mei, Helen A. Holder, and Hubert A. Vander Plas, August 1996, Hewlett-Packard Journal. Suitable solder alloys having a “Liquidus Temperature” below 250 degrees Fahrenheit can be employed in place of conventional solder to attach the light emitting devices and other components such as current limiting resistors, to the conductive traces or pads on a flexible substrate. As a further alternative, conductive adhesives, such as conductive epoxy, can be used for this purpose. An example of such conductive epoxy is EP-600™ Silver Filled Electrically Conductive Two Part Epoxy Adhesive, which is available from Conductive Compounds, Inc., Hudson, N.H.

TABLE I
Low-Melting Alloys

| | Liquidus | Solidus |
|---|---|---|
| | Temperature | Temperature |
| Chemical Composition | (° C.) | (° C.) |
| 49Bi21In18Pb12Sn | 58 | 58 |
| 51In32.5Bi16.5Sn | 60 | 60 |
| 49Bi18Pb18In15Sn | 69 | 58 |
| 66.3In33.7Bi | 72 | 72 |
| 57Bi26In17Sn | 79 | 79 |
| 54.02Bi29.68In16.3Sn | 81 | 81 |
| 51.45Bi31.35Pb15.2Sn2In | 93 | 87 |
| 52Bi31.7Pb15.3Sn1In | 94 | 90 |
| 52.5Bi32Pb15.5Sn | 95 | 95 |
| 52Bi32Pb16Sn | 95.5 | 95 |
| 52Bi30Pb18Sn | 96 | 96 |
| 50Bi31Pb19Sn | 99 | 93 |
| 50Bi28Pb22Sn | 100 | 100 |
| 46Bi34Sn20Pb | 100 | 100 |
| 50Bi25Pb25Sn | 115 | 95 |
| 56Bi22Pb22Sn | 104 | 95 |
| 50Bi30Pb20Sn | 104 | 95 |
| 52.2Bi37.8Pb10Sn | 105 | 98 |
| 45Bi35Pb20Sn | 107 | 96 |
| 46Bi34Pb20Sn | 108 | 95 |
| 54.5Bi39.5Pb6Sn | 108 | 108 |
| 67Bi33In | 109 | 109 |
| 51.6Bi41.4Pb7Sn | 112 | 98 |
| 52.98Bi42.49Pb4.53Sn | 117 | 103 |
| 52In48Sn | 118 | 118 |
| 53.75Bi43.1Pb3.15Sn | 119 | 108 |
| 55Bi44Pb1Sn | 120 | 117 |
| 55Bi44Pb1In | 121 | 120 |
| 55.5Bi44.5Pb | 124 | 124 |
| 50In50Sn | 125 | 118 |
| 58Bi42Pb | 126 | 124 |
| 38Pb37Bi25Sn | 127 | 93 |
| 51.6Bi37.4Sn6In5Pb | 129 | 95 |
| 40In40Sn20Pb | 130 | 121 |
| 52Sn48In | 131 | 118 |
| 34Pb34Sn32Bi | 133 | 96 |
| 56.84Bi41.16Sn2Pb | 133 | 128 |
| 38.41Bi30.77Pb30.77Sn0.05Ag | 135 | 96 |
| 57.42Bi41.58Sn1Pb | 135 | 135 |
| 36Bi32Pb31Sn1Ag | 136 | 95 |
| 55.1Bi39.9Sn5Pb | 136 | 121 |
| 36.5Bi31.75Pb31.75Sn | 137 | 95 |
| 43Pb28.5Bi28.5Sn | 137 | 96 |
| 58Bi42Sn | 138 | 138 |
| 38.4Pb30.8Bi30.8Sn | 139 | 96 |
| 33.33Bi33.34Pb33.33Sn | 143 | 96 |
| 97In3Ag | 143 | 143 |
| 58Sn42In | 145 | 118 |
| 80In15Pb5Ag | 149 | 142 |
| 99.3In0.7Ga | 150 | 150 |
| 95In5Bi | 150 | 125 |
| 42Pb37Sn21Bi | 152 | 120 |
| 99.4In0.6Ga | 152 | 152 |
| 99.6In0.4Ga | 153 | 153 |
| 99.5In0.5Ga | 154 | 154 |
| 100In | 156.7 | 156.7 |
| 54.55Pb45.45Bi | 160 | 122 |
| 70Sn18Pb12In | 162 | 162 |
| 48Sn36Pb16Bi | 162 | 140 |
| 43Pb43Sn14Bi | 163 | 144 |
| 50Sn40Pb10Bi | 167 | 120 |
| 51.5Pb27Sn21.5Bi | 170 | 131 |
| 60Sn40Bi | 170 | 138 |
| 50Pb27Sn20Bi | 173 | 130 |
| 70In30Pb | 175 | 165 |
| 47.47Pb39.93Sn12.6Bi | 176 | 146 |
| 62.5Sn36.1Pb1.4Ag | 179 | 179 |
| 60Sn25.5Bi14.5Pb | 180 | 96 |
| 37.5Pb37.5Sn25In | 181 | 134 |

FIG. 2 illustrates a roll 200 of an exemplary flexible, clear and transparent lighting strip similar to that shown in FIG. 1. A flexible substrate 202 that is fabricated, for example, of PET, includes a plurality of light emitting devices 204 mounted at spaced apart locations along the length of the flexible substrate. Flexible power bus traces and conductive traces used to convey electrical current to the light emitting devices are not shown in this Figure.

The flexible substrate and flexible power bus traces are sufficiently flexible to enable the flexible, clear and transparent lighting strip to be rolled into multiple concentric layers, as shown in FIG. 2, without damage to the lighting strip or its components. Roll 200 thus facilitates transport of the flexible, clear and conductive lighting strip to a location where it will be installed to provide decorative lighting and/or illumination. For example, the flexible, clear and transparent lighting strip can be cut to a desired length and mounted in windows or in display cases. A DC power source (like DC power source 102), can be connected through leads (not shown) to the flexible power bus traces on flexible substrate 202 using appropriate mechanical means or using solder alloy or conductive adhesive like that used on the lighting strip, and the power source can then supply electrical current to energize light emitting devices 204. Because flexible substrate 202 used in flexible, clear and transparent lighting strip 200 is not very visible when mounted on a glass or other transparent surface, it does not obstruct the view of other objects disposed behind it and is generally unobtrusive—whether energized or not. The light from light emitting devices 204 is visible from either side of the flexible, clear and transparent lighting strip, so that it is decorative and provides illumination of nearby surfaces and objects on both sides of the flexible, clear and transparent lighting strip.

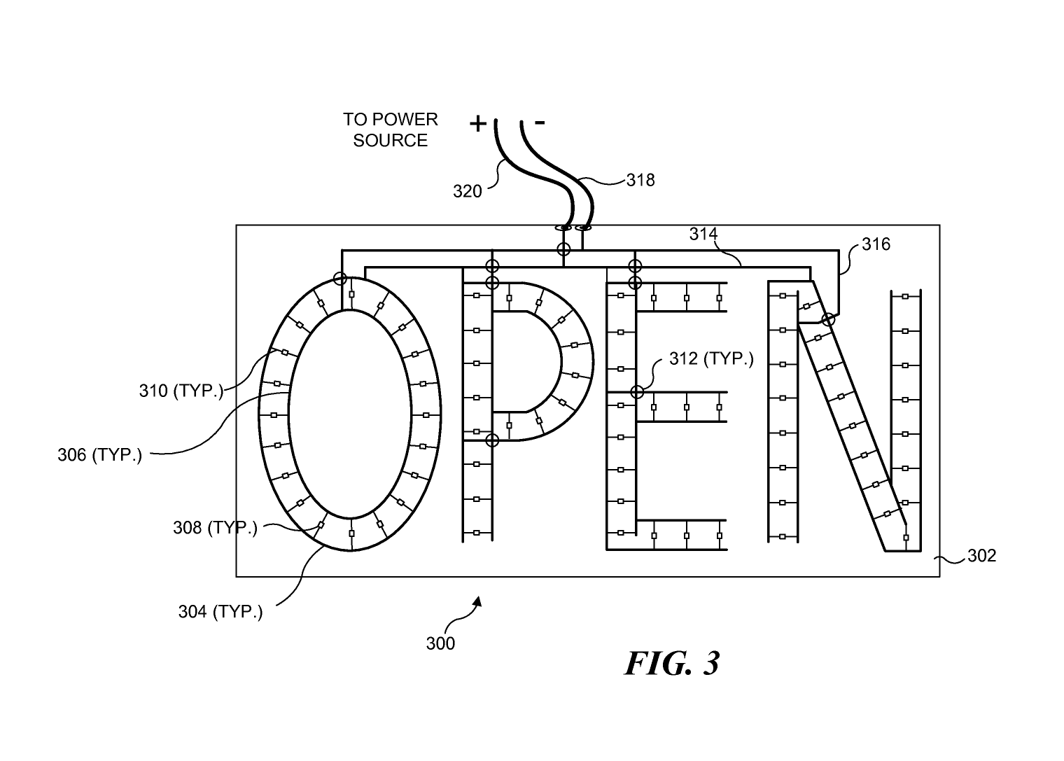

The same approach used to produce the flexible, clear and transparent lighting strips can be applied to produce lighted signs that are clear and transparent (and optionally flexible). FIG. 3 illustrates an exemplary such lighted sign 300 that is formed on a flexible, clear and transparent substrate 302, which can be made of PET or any other suitable flexible, clear and transparent dielectric material, as discussed above in connection with the flexible substrates used for the flexible lighting strips. It is also contemplated that in some applications in which the sign is attached to a generally planar surface and need not be formed in a curve for mounting on a curved surface or rolled for ease in transport, it may not be necessary to employ a flexible material for the substrate. For such applications, a clear and transparent material of limited flexibility, such as glass, may alternatively be used to produce lighted signs.

Lighted sign 300 includes a plurality of letters spelling the word “OPEN,” which is simply one example of what may be included on such a lighted sign The letters are each defined using flexible power bus traces 304 and 306 formed of a conductive metal that is non-transparent, as discussed above in regard to the flexible, clear and transparent lighting strip. Light emitting devices 308, such as LEDs, which are spaced apart along a locus of points that form each letter, are connected to flexible power bus traces 304 and 306 through conductive traces 310 (and optionally, through series connected current limiting resistors—not shown in this Figure), using a solder alloy having an appropriate melting temperature that is below the working or processing temperature of the substrate, or a conductive adhesive, as discussed above. The flexible power bus traces and conductive traces can be formed on flexible substrate 302 by using conventional removal techniques to eliminate portions of conductive metal foil cladding on the substrate. At each point where one of the flexible power bus traces crosses over another flexible power bus trace of a different polarity, insulating pads 312 are provided so that the crossing flexible power bus traces do not cause an electrical short circuit. Power source traces 314 and 316, which convey electrical current to the flexible power bus traces defining each letter of sign 300 are connected to leads 318 and 320, respectively. Leads 318 and 320 can be connected to a suitable power source, such as the DC power source discussed above and used in connection with the flexible, clear and transparent lighting strips.

It will be apparent that flexible, clear and transparent lighted signs with more or fewer letters can be created using the same techniques employed in connection with flexible, clear and transparent sign 300. Such signs can also be made to include multiple lines and to define graphic designs in place of or in addition to one or more alphanumeric characters. For example, a logo trademark might be produced by using the light emitting devices that are mounted on the flexible, clear and transparent substrate to define the shape of the logo and to visually represent other of the characteristics of the logo. Thus, lighted signs having almost any form of graphic designs and/or alphanumeric text can be created in this manner. Such signs can be easily hung or mounted in windows, display cases, or on other types of transparent or opaque surfaces, and the lighted signs will not obscure the surface on which the sign is mounted or hung, or items that would otherwise be visible behind the signs.

A short section of an exemplary flexible, clear and transparent lighting strip 400 is illustrated in FIGS. 4A and 4B, and in cross-sectional view in FIG. 4C. Flexible, clear and transparent lighting strip 400 includes a flexible, clear and transparent substrate 402 that is produced using a suitable material such as PET, which has the flexibility and other desired physical or visual characteristics, although other electrically insulating material with adequate dielectric properties, that are flexible, clear and transparent may instead be used. Conventional methods are used to form flexible power bus traces 404 and 406 on at least one surface of the substrate, of non-transparent conductive metal. For example, as discussed above, portions of copper or other non-transparent metallic conductor cladding on that surface can be selectively removed using acid etch, laser ablation, or other suitable techniques, to form flexible power bus traces 404 and 406. At the same time, conductive traces 408 and 410 can be formed at each point along the flexible power bus traces where a light emitting device 412 is to be mounted. Terminals 418 of each light emitting device 412 are coupled to a conductive trace 408 on one side of the light emitting device, and to one end of a current limiting resistor 414 on the other side of the light emitting device. The opposite end of the current limiting resistor is connected to conductive trace 410. The electrical connections are made using drops 416 of a suitable solder alloy selected to have a melting temperature below the maximum processing or working temperature of the material used for flexible, clear and transparent substrate, e.g., below about 250 degrees Fahrenheit for PET, or alternatively, an electrically conductive adhesive, such as conductive epoxy can be used to make each electrical connection. Drops 416 of the solder alloy (or of the conductive adhesive) are used for electrically connecting and mounting terminals 418 of each light emitting device 412 to a conductive pad 420 and conductive trace 408. Current limiting resistors 414 are optionally used unless other means are employed to limit the electrical current flowing through each light emitting device 412 to be less than the maximum rated current for the light emitting device.

It should be noted that the light emitting devices used in each of the exemplary embodiments discussed above can emit white light or can be selected to emit light of one or more other desired colors. The decorative aspect of these flexible, clear and transparent lighting strips and lighted signs is thus dramatically enhanced by an appropriate selection of the light emitting devices to emit appropriate one or more colors of light.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

What is claimed is:

1. A flexible, clear and transparent lighting strip, comprising:
(a) a flexible, clear and transparent substrate, characterized by a dielectric strength of an electrical insulator;
(b) a plurality of flexible power bus traces formed on the flexible, clear and transparent substrate and extending along at least one surface of the flexible, clear and transparent substrate, comprising a non-transparent conductive metal;
(c) a plurality of conductive traces formed on the flexible, clear and transparent substrate and disposed at spaced apart locations along the plurality of flexible power bus traces, wherein each of the plurality of conductive traces is electrically connected to one of the plurality of flexible power bus traces; and
(d) a plurality of light emitting devices spaced apart along the flexible, clear and transparent substrate and having terminals electrically connected through the conductive traces to the plurality of flexible power bus traces, to receive electrical current when the plurality of flexible power bus traces are connected to a power source, and in response to the electrical current, emitting light, the terminals of the plurality of light emitting devices being electrically connected to the conductive traces using either an electrically conductive adhesive, or a solder alloy selected for a characteristic melting temperature that is sufficiently below a temperature that would damage the flexible, clear and transparent substrate.

2. The flexible, clear and transparent lighting strip of claim 1, wherein the flexible, clear and transparent substrate comprises a strip of polyethylene terephthalate (PET) plastic.

3. The flexible, clear and transparent lighting strip of claim 2, wherein if the solder alloy is used to electrically couple the terminals of the plurality of light emitting devices to the plurality of conductive traces, the solder alloy has a melting point below about 250 degrees Fahrenheit.

4. The flexible, clear and transparent lighting strip of claim 1, wherein the plurality of light emitting devices comprise light emitting diodes (LEDs).

5. The flexible, clear and transparent lighting strip of claim 1, wherein the flexible, clear and transparent substrate and the plurality of flexible power bus traces are sufficiently flexible to enable the flexible, clear and transparent lighting strip to be rolled into multiple concentric layers without damage.

6. The flexible, clear and transparent lighting strip of claim 1, further comprising a plurality of current limiting resistors, wherein a current limiting resistor is mounted in series between each of the plurality of light emitting devices and one of the plurality of flexible power bus traces, using either the electrically conductive adhesive or the solder alloy.

7. The flexible, clear and transparent lighting strip of claim 1, wherein the flexible power bus traces comprise a conductive metal cladding applied to the flexible, clear and transparent substrate.

8. The flexible, clear and transparent lighting strip of claim 1, wherein the plurality of light emitting devices are characterized by emitting light of a selected color or a plurality of different selected colors when energized.

9. A light emitting sign comprising:
(a) a clear and transparent substrate sheet, characterized by a dielectric strength of an electrical insulator;
(b) a plurality of power bus traces formed on the clear and transparent sheet to define at least one selected from the group consisting of:
(i) a graphic design; and
(ii) at least one alphanumeric character;
(c) a plurality of conductive traces formed on the clear and transparent substrate sheet, each of the plurality of conductive traces being electrically connected to one of the plurality of power bus traces at spaced apart locations; and
(d) a plurality of light emitting devices having terminals electrically connected to the plurality of power bus traces through the plurality of conductive traces, so that the plurality of light emitting devices are applied to the clear and transparent substrate between pairs of the plurality of power bus traces and when energized by an electrically current supplied from a power source connected to the plurality of power bus traces, emit light in patterns defining the at least one of the graphic design, and the at least one alphanumeric character, the terminals of the plurality of light emitting devices being electrically connected to the conductive traces using either an electrically conductive adhesive, or a solder alloy selected for a characteristic melting temperature that is sufficiently below a temperature that would damage the clear and transparent substrate sheet.

10. The light emitting sign of claim 9, wherein the clear and transparent substrate sheet and the plurality of power bus traces are sufficiently flexible to enable the light emitting sign to be flexed around a curved supporting surface or rolled for transport without damage.

11. The light emitting sign of claim 10, wherein the clear and transparent substrate sheet comprises a sheet of polyethylene terephthalate (PET) plastic.

12. The light emitting sign of claim 11, wherein if the solder alloy is used to electrically couple the terminals of the plurality of light emitting devices to the plurality of conductive traces, the solder alloy has a melting point below about 250 degrees Fahrenheit.

13. The light emitting sign of claim 9, wherein the plurality of light emitting devices comprise light emitting diodes (LEDs).

14. The light emitting sign of claim 9, further comprising a plurality of current limiting resistors, wherein a current limiting resistor is mounted in series between each of the plurality of light emitting devices and one of the plurality of power bus traces, using either the electrically conductive adhesive or the solder alloy.

15. The light emitting sign of claim 9, wherein the flexible power bus traces comprise a conductive metal cladding applied to the clear and transparent substrate sheet.

16. The light emitting sign of claim 9, wherein the plurality of light emitting devices are characterized by emitting light of a selected color or a plurality of different selected colors when energized.

17. A method for producing a flexible, clear and transparent lighting strip, comprising:
(a) providing a flexible, clear and transparent substrate with a conductive metal cladding on at least one surface;
(b) creating a plurality of flexible power bus traces extending along the at least one surface of the flexible, clear and transparent substrate by removing portions of the conductive metal cladding;
(c) creating a plurality of conductive traces on the at least one surface of the flexible, clear and transparent substrate, by removing other portions of the conductive metal cladding, wherein each of the plurality of conductive traces is electrical connected to one of the plurality of flexible power bus traces; and
(d) mounting terminals of a plurality of light emitting devices to the flexible, clear and transparent substrate using either a conductive adhesive or a solder alloy to electrically connect the terminals to the plurality of conductive traces.

18. The method of claim 17, wherein providing the flexible, clear and transparent substrate comprises providing a strip of polyethylene terephthalate (PET) plastic that includes the conductive metal cladding on at least one surface.

19. The method of claim 17, wherein mounting the terminals of the plurality of light emitting devices to the flexible, clear and transparent substrate using the solder alloy includes using a solder alloy that has a melting point less than about 250 degree Fahrenheit.

20. The method of claim 17, further comprising mounting a current limiting resistor between one terminal of each of the plurality of light emitting devices and one of the conductive traces, using either the conductive adhesive or the solder alloy.
